(19) United States
(12) Patent Application Publication
(10) Pub. No.: US 2003/0142959 A1
(43) Pub. Date: Jul. 31, 2003

(54) Anti-copying method and apparatus

(76) Inventor: Tony Qu, San Ramon, CA (US)

Correspondence Address: OPPENHEIMER WOLFF & DONNELLY, P. O. BOX 10356, PALO ALTO, CA, 94303, US

(21) Appl. No.: 10/062,573

(22) Filed: Jan. 30, 2002

(51) Int. Cl. H04N 5/76; G11B 15/04; G11B 19/04

(52) U.S. Cl. 386/94; 386/95; 380/201; 360/60

(57) ABSTRACT

The present invention teaches anti-copy protection and control of an underlying anti-copy protection mechanism through anti-copy protection codes inserted into a video program. The anti-copy protection code may be inserted into closed caption (CC) bandwidth. The anti-copy protection codes of the present invention are suitable for use with analog and digital video programs. The present invention contemplates anti-copy protection mechanisms having multiple levels of anti-copy protection. These multiple levels of anti-copy protection may include varying levels of degradation of subsequent copies as well as absolute prohibition of subsequent copying.

### CROSS REFERENCE TO RELATED APPLICATIONS

Reference is made and priority claimed to Tony Qu's U.S. Provisional Application No. 60/237,285 entitled Anti-Copying Method and Apparatus, filed Nov. 30, 2001.

### BACKGROUND OF THE INVENTION

1. Field of the Invention

The present invention relates to video signal copy protection technology. In particular, the present invention teaches a method and apparatus for encoding a video signal such that a television receiver may still produce a normal viewing picture from the encoded signal, but any attempt to copy the video program onto video tape or other media is effected through degradation or prohibition.

2. Description of the Related Art

To protect valuable rights in video information, there exists a need for an improved method and apparatus for modifying a video signal so that a normal color picture may be produced by a television receiver receiving the modified video signal, but recording of the modified video signal is prevented. It is of further interest that the modified signal have a minimal impact on the quality of the picture being viewed by the television audience. This is increasingly important as large screen, high resolution monitors become widespread, and high picture quality essential. It is also important that copy protection be compatible with digital television processes and components, and that copying to other forms of digital storage media be prohibited, in addition to video tape.

Ryan's U.S. Pat. Ser. No. 4,631,603, hereinafter referred to as Macrovision copy protection, describes what will be appreciated to be the current state of the art in anti-copying technology. According to the Macrovision copy protection, a video signal to be protected is modified by inserting a plurality of pseudo-sync pulse and positive pulse pairs into a color video signal in the vertical blanking region. Many videotape recorders include an Automatic Gain Control (AGC) circuit and these added pulse pairs cause the AGC circuit to erroneously sense video signal levels. The AGC circuit then produces a gain correction that results in an unacceptable videotape recording, thus providing the desired anti-copying protection.

The effect of the Macrovision copy protection is not completely benign. Rather, the pseudo-sync and positive pulse have a negative impact on displayed video performance, especially in high definition, high performance television systems. It is also well known that the Macrovision copy protection can be defeated with simple analog circuits, and is generally only effective in certain brands of video tape recorders whose automatic gain control circuits (AGC) have been adjusted to respond to the Macrovision signals. Further, there is no protection for Macrovision encoded media when users employ recording devices that are not video tape recorders, such as digitally based storage media or encoders.

In a prior method of copy protection described by Ezaki et al. (U.S. Pat. Ser. No. 6,266,480), transmitted video signals are modified in a manner similar to that described by Ryan above, except that parameters associated with the pseudo-sync pulse and positive pulse pairs are altered based on information of the user's television receiver. It is expected that fine tuning of the parameters associated with the injected pulses will minimize the impact on the picture quality. This may work until the user buys another receiver, or buys multiple, different branded receivers for use in the same household. This system also requires the user to feedback current and accurate information regarding their television products. Such feedback may be prone to errors.

What is needed is an improved method and apparatus for modifying a video signal so that copying of the modified signal is prevented in a reliable and inexpensive manner, is not easily defeated, yet allows a normal color picture to be produced by a television receiver receiving the modified video signal with no impact on picture quality.

### SUMMARY OF THE INVENTION

### BRIEF DESCRIPTION OF THE DRAWINGS

FIG. 1 is a flow chart showing an anti-copy protection encoding method of the present invention;

FIG. 2 is a flow chart showing an anti-copy protection encoding method according to another aspect of the present invention;

FIG. 3 is a flow chart showing an anti-copy protection encoding method in accordance with another embodiment of the present invention;

FIG. 4 illustrates an encoding system in accordance with one embodiment of the present invention;

FIG. 5 illustrates another a preferred encoding system in accordance with another embodiment of the present invention;

FIG. 6 illustrates an anti-copy protection encoder in accordance with one embodiment of the present invention;

FIG. 7 shows a timing diagram of the NTSC vertical blanking interval of a video waveform;

FIG. 8 is a table of two byte character codes assigned by specification EIA-608;

FIG. 9 illustrates a method for decoding an analog video program according to one aspect of the present invention;

FIG. 10 is a component block diagram showing the decoding of copy protected video programs in accordance with one embodiment of the present invention;

FIG. 11 is a flow chart for encoding digital video data with anti-copy protection information in accordance with one embodiment of the present invention; and,

FIG. 12 a flow chart of a digital decoding method in accordance with another embodiment of the present invention;

FIG. 13 is a block diagram of a hardware system for the decoding of digital video data in accordance with yet another embodiment of the present invention; and

FIG. 14 is a block diagram illustrating a variety of program sources which may be encoded with anti-copy protection codes of the present invention.

### SUMMARY OF THE INVENTION

The present invention teaches a variety of methods, systems and articles of manufacture for providing anti-copy protection and control of an underlying anti-copy protection mechanism. The anti-copy protection mechanism is controlled through anti-copy protection codes inserted into a video program. In preferred embodiments, the anti-copy protection code is inserted into closed caption (CC) bandwidth. As used herein, the term CC bandwidth refers to the capacity for insertion of closed caption data within the video program.

The encoding methods of the present invention effectuate control of an underlying anti-copy protection mechanism by encoding a video program prior to use by an end user. The underlying anti-copy protection mechanism is implemented at a video program receiving device such as a STB or other such suitable device. The anti-copy protection codes may be inserted into a video program at any suitable stage during the provision of the video program to an end user such as during content authoring or video broadcast.

The anti-copy protection codes of the present invention are suitable for use with analog and digital video programs. The preferred embodiment of the present invention utilizes CC bandwidth, and there exist both analog and digital video formats which support CC data encoding. The present invention is not limited to formats supporting CC data encoding.

The present invention also teaches that the underlying anti-copy protection mechanism can be implemented in a variety of ways. The present invention contemplates anti-copy protection mechanisms having multiple levels of anti-copy protection. These multiple levels of anti-copy protection may include varying levels of degradation of subsequent copies as well as absolute prohibition of subsequent copying.

A first aspect of the present invention teaches a video encoding method for providing control of an anti-copy protection mechanism for a video program, the video encoding method encoding at least one anti-copy protection code within CC bandwidth of said video program. Another embodiment of the present invention teaches a computer readable medium encoded with at least one anti-copy protection code within closed captioning (CC) bandwidth of said video program. A still further embodiment teaches a video program encoded with at least one anti-copy protection code within CC bandwidth of the video program. The present invention also teaches a data carrier wave having at least one anti-copy protection code encoded within a portion of the data carrier wave intended for use in providing closed caption (CC) data.

Related aspects of the present invention teach an underlying anti-copy protection mechanism responsive to a frequency of insertion of said anti-copy protection codes. The method operates such that certain portions of the video program or computer readable medium are encoded with anti-copy protection codes at a frequency of insertion such that the anti-copy protection mechanism is controlled as desired.

Other related embodiments teach that activation of the anti-copy protection mechanism is initiated when the frequency of insertion of the anti-copy protection codes is greater than or equal to an anti-copy protection initiation frequency. The anti-copy protection mechanism may be maintained in an on state when the frequency of insertion of the anti-copy protection codes is greater than or equal to an anti-copy protection maintenance frequency, the anti-copy protection maintenance frequency possibly being less than the anti-copy protection initiation frequency.

Another preferred embodiment of the present invention teaches an anti-copy protection video program encoding system operable to insert anti-copy protection codes within closed captioning bandwidth of a video program. A related embodiment teaches an encoding system having a data merger device and a CC encoder. In preferred embodiments, the data merger device has a first CC data input, an anti-copy data input, and a CC data output. The data merger device is operable to merge data received at the anti-copy data input and the specific CC data output. The CC encoder has a second CC data input coupled to the data merger device CC data output, a video data input, and a video data output. The CC encoder is operable to encode data received at the second CC data input within a CC bandwidth portion of a video program received at the video input. The present invention teaches anti-copy protection video program encoding systems operable for either analog or digital video.

The present invention still further contemplates an anti-copy protection decoding method which receives a video program, and analyzes a CC portion of the video program for anti-copy protection codes. The method teaches controlling the anti-copy protection mechanism as indicated by the anti-copy protection codes. In a related aspect of the present invention, the anti-copy protection mechanism is activated at least when a frequency of anti-protection encoding within the video program is greater than or equal to a predefined activation frequency. According to this aspect, analyzing the anti-copy protection codes within the CC portion of the video program includes determining the frequency of anti-protection encoding within the video program.

Yet another aspect of the present invention teaches a method for anti-copy protection in an video program including encoding a video program with a two byte character code in a vertical blanking interval of a video field such that the two byte character code may be decoded in a video recording device in order to disable a recording process of the video program. The method also teaches disabling the recording process in response to a content of the two byte character code.

Another related aspect of the present invention teaches storing a reference two byte code in a video recording device, comparing the reference two byte character code with the two byte character code, and disabling the recording process based on a comparison of the two byte character code and the reference two byte character code. The present invention further teaches a method for recording a copy-protected video program with a video recording device including decoding a two byte character code in a vertical blanking interval of a video field, and enabling recording of the video program in response to the two byte character code.

Still further, the present invention teaches a video transmission receiver for receiving copy protected video programs. The video transmission receiver of this aspect includes a decoding device for decoding copy protection codes incorporated in a video program, a memory operative for storing a reference code, a comparator for comparing the reference code with the copy protection codes in order to produce an output responsive to the reference code and the copy protection codes; a control device operative to limit recording and playback of the video program in response to the output of the comparator, and a recording device for recording and playback of the video program.

### DETAILED DESCRIPTION OF THE PREFERRED EMBODIMENT(S)

The present invention teaches methods and apparatus for providing anti-copy protection and control of an underlying anti-copy protection mechanism through anti-copy protection codes inserted into a video program. In preferred embodiments, the anti-copy protection code is inserted into closed caption (CC) bandwidth. As used herein, the term CC bandwidth refers to the capacity for insertion of closed caption data within the video program. In an analog video program, e.g., anti-copy protection codes can be inserted into line 21 of the Vertical Blanking Interval (VBI). Those skilled in the art will appreciate that often little of the CC bandwidth is used and is thus readily available for the encoding of the present invention.

The encoding methods of the present invention effectuate control of an underlying anti-copy protection mechanism by encoding a video program prior to use by an end user. The underlying anti-copy protection mechanism is implemented at a video program receiving device such as a STB or other such suitable device. Hence the anti-copy protection codes of the present invention may be encoded into a video program at any suitable stage during the process of providing the video program to an end user.

In preferred embodiments, the necessary anti-copy protection codes are inserted while authoring the video program and in conjunction with encoding of any desired CC data. Of course, during the full process of providing the video program to the end user there are many suitable opportunities for encoding anti-copy protection into the video program. For example, the anti-copy protection codes may be inserted subsequent to authoring and simultaneously with broadcast of the video program or even at the end user's receiving device (e.g., a set top box).

The anti-copy protection codes of the present invention are suitable for use with analog and digital video programs. The preferred embodiment of the present invention utilizes CC bandwidth, and there exist both analog and digital video formats which support CC data encoding. The present invention is not limited to formats supporting CC data encoding and methods and devices for implementing the present invention in formats which do not directly support CC data encoding are described below in more detail.

As will be described below in more detail, the underlying anti-copy protection mechanism can implement anti-copy protection in a variety of ways. The present invention contemplates anti-copy protection mechanisms having multiple levels of anti-copy protection. These multiple levels of anti-copy protection may include varying levels of degradation of subsequent copies as well as absolute prohibition of subsequent copying.

In the following description, certain method aspects of the present invention are described with reference to flow chart figures. These method steps need not be performed in a sequential manner as might be implied by such flow chart figures. Rather, the methods of the present invention should be implemented in the appropriate manner determined by those skilled in the art depending upon the underlying hardware and the specific application.

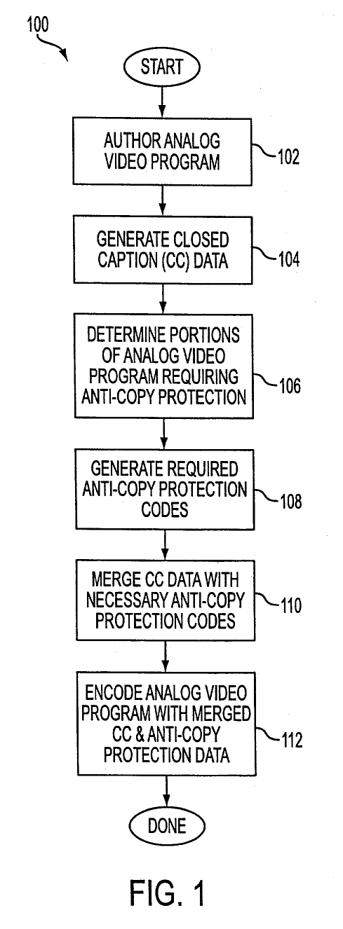

FIG. 1 is a flow chart showing an anti-copy protection analog video encoding method 100 in accordance with a preferred embodiment of the present invention. The method 100 effectuates control of the underlying anti-copying mechanism by encoding at the time of video content authoring. The method 100 begins in a content authoring step 102 where an analog video program is initially authored or created. As will be appreciated, content authoring may accomplished in a variety of ways. For example, content authoring can be done “off-line” in a recording studio, or may be the result of content creation during a live broadcast.

With further reference to FIG. 1, a step 104 generates any desired CC data intended for use with the analog video program. The CC data generation may occur simultaneous with content authoring, or may be performed subsequently. The CC data may be created in real time simultaneous with a live broadcast. The step 104 is an optional step, as there may be no need for CC data or perhaps CC data will be later inserted.

A step 106 of FIG. 1 determines or defines those portions of the analog video program requiring anti-copy protection. A step 108 generates the required anti-copy protection codes. The necessary codes depend upon the nature of the underlying anti-protection mechanism and the CC standard adhered to. For example, in the EIA-608 standard (7 bit code, 1 parity), a special and unused 2-byte character such as (1F, 60) or (1F, 61) would be suitable for use as an anti-copy protection code.

A step 110 merges the CC data together with anti-copy protection codes to effectuate the required anti-copy protection. The step 110 can be accomplished in a variety of ways. In preferred embodiments, the anti-copy protection codes and any CC data are encoded within mutually exclusive portions of the CC bandwidth such that the merger step 110 creates no risk of loosing encoded data. When the anti-copy protection codes and the CC data are not encoded simultaneously, the analog video signal can be examined to insure that neither step results in the loss of data. Alternatively, the anti-copy protection codes can be inserted into a least used portion of the CC bandwidth such as CC3 or CC4, thereby minimizing any risk of data loss. In any event, a step 110 encodes the analog video program with the merged CC data and anti-copy protection codes. Once the analog video program is encoded in the step 110, the analog video program is ready for distribution through any variety of mechanisms (e.g., broadcast, sale of video tapes, etc.)

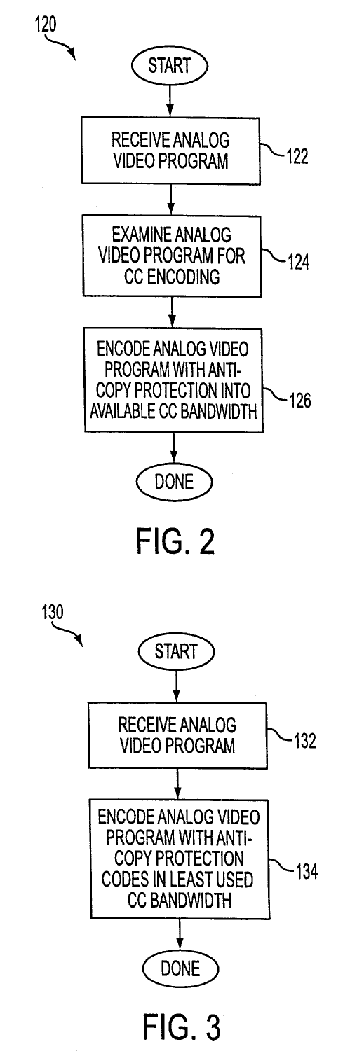

FIG. 2 is a flow chart showing an anti-copy protection analog video encoding method 120 in accordance with another embodiment of the present invention. The method 120 is suitable for encoding analog video program with anti-copy protection codes subsequent to content authoring and CC data encoding. A step 122 receives an analog video program which may contain CC encoding. Accordingly, a step 124 examines the CC bandwidth of the analog video program to determine if and where CC information is encoded. A step 126 encodes the analog video program with anti-copy protection coding within unused CC bandwidth. As will be appreciated, the typical video program will have a sufficient surplus of CC bandwidth to enable such encoding. Steps 124 and 126 are typically performed in conjunction, e.g., together frame by frame. Of course the present invention does not preclude an a priori analysis of the video program should such an approach be desirable or necessary for a given application.

FIG. 3 is a flow chart showing an anti-copy protection analog video encoding method 130 in accordance with a third embodiment of the present invention. The method 130 is suitable for encoding an analog video program with anti-copy protection codes subsequent to content authoring and CC data encoding. A step 122 receives an analog video program which may contain CC encoding. The method 130 avoids any complicated CC data analysis by an educated guess as to the whereabouts of available CC bandwidth. Thus a step 134 encodes the analog video program with anti-copy protection codes in a least used portion of the CC bandwidth. As will be appreciated, the typical video program has a sufficient surplus of CC bandwidth to enable such encoding without great risk of overwriting data. For example CC3 and CC4 are often unused in typical applications common at the time of filing of the present invention.

Certain digital video standards (e.g., EIA-708) provide for CC capability. Those skilled in the art will readily understand how to modify the methods of FIGS. 1-3 so that they apply within a digital video context supporting CC capabilities. Alternatively, the anti-copy protection encoding methods described with reference to FIGS. 2-3 may be used in conjunction with a digital video broadcast system by encoding anti-copy protection data within the digital video program and implementing the encoding methods at any point in the process where the digital video is converted to an analog video program, e.g. at a user's STB. Underlying anti-copy protection mechanisms, and the implementation within a digital video broadcast system are described below in more detail.

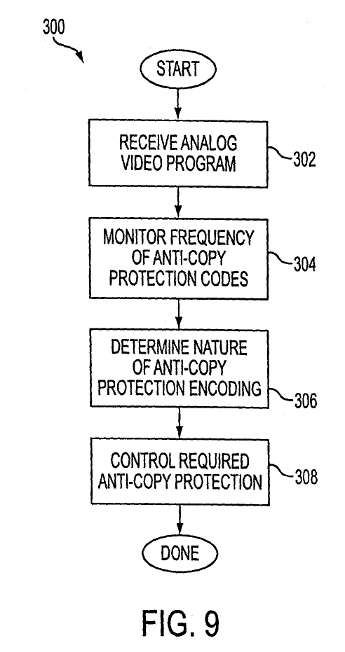

A plethora of suitable schemes are contemplated for controlling the anti-copy protection mechanism. A preferred embodiment teaches the insertion of an anti-copy protection activation code at one or more predefined frequencies within the CC bandwidth. The term “frequency” as used herein is defined loosely as the rate at which anti-copy protection codes or information are encoded within the video program. As will be described further with reference to FIG. 9, this technique allows the video program receiving device (e.g., STB) to control the anti-copy protection mechanism based on a sensed frequency of the anti-copy protection codes within the received video program. In a first embodiment, the anti-copy protection mechanism is activated by an anti-copy protection code frequency equal to or greater than a predefined value. The inverse of this is also contemplated; that is, anti-copy protection may be activated when the anti-copy protection code frequency falls below a predefined value.

In certain embodiments, the frequency requirement for initiating anti-copy protection activation may differ from maintaining anti-copy protection activation. For example, an anti-copy protection maintenance frequency could be lower than an anti-copy protection initiation frequency.

It is further contemplated that the nature of the anti-copy protection may vary depending on the anti-copy protection code itself, or even upon the frequency of the anti-copy protection code. The anti-copy protection mechanism could be responsive to multiple anti-copy protection codes. By way of example, different anti-copy protection codes may correspond to different levels of degradation in a subsequent copy including and up to complete prohibition of copying, or even disabling any recording device. Likewise, the level of anti-copy protection could correspond to a frequency or frequency range of the anti-copy protection encoding.

The present invention further contemplates an activate/deactivate anti-copy protection scheme. In the activate/deactivate anti-copy protection scheme, an activate anti-copy protection code can be inserted at least once but more likely multiple times into sequential line 21 VBIs of the analog video signal at a point where activation of the anti-copy protection mechanism is desired. Similarly, a deactivate anti-copy protection code is inserted at least once but more likely multiple times into sequential line 21 VBIs at a point where anti-copy protection is no longer desired in the analog video signal. A drawback to this embodiment arises in that the user video program access time is unpredictable. Hence if the user accesses the video program after the activate sequence or before the deactivate sequence, the anti-copy protection mechanism may fail to work properly. Multiple transmissions of the anti-copying sequence may be inserted into the video program to overcome this problem. Details of implementation will be readily apparent to those skilled in the art in light of the present teaching.

Further schemes for controlling the anti-copy protection mechanism are contemplated. For example, the insertion of one or multiple sequential anti-copy protection codes could correspond to a predefined time period of activation of the anti-copy protection code. Alternatively, the anti-copy protection mechanism could be deactivated by an end of program marker or other feature of the analog video program rendering the anti-copy protection mechanism simpler as no deactivate anti-copy protection code is necessary. In any event, the present invention is not limited by the nature of the underlying anti-copy protection mechanism, but rather provides a broad framework wherein those skilled in the art will find a powerful solution to a previously inadequately addressed problem.

As will be appreciated, the anti-copy protection encoding methods of the present invention can be implemented through a variety of devices. In one embodiment, a CC encoder may be designed with enhanced capability for encoding an analog video signal with the necessary anti-copy protection codes. Alternatively, an anti-copy protection encoder lacking closed caption encoding capabilities can be designed for the sole purpose of inserting only the anti-copy protection codes into the analog video program. This anti-copy protection encoder can be used in conjunction with a suitable closed caption encoder as describe below with reference to FIG. 6, or be used alone where no closed captioning encoding capability is desired or necessary. In another embodiment, a separate device provides the anti-copy protection codes into the input of a standard line closed caption encoder as described below with reference to FIG. 5.

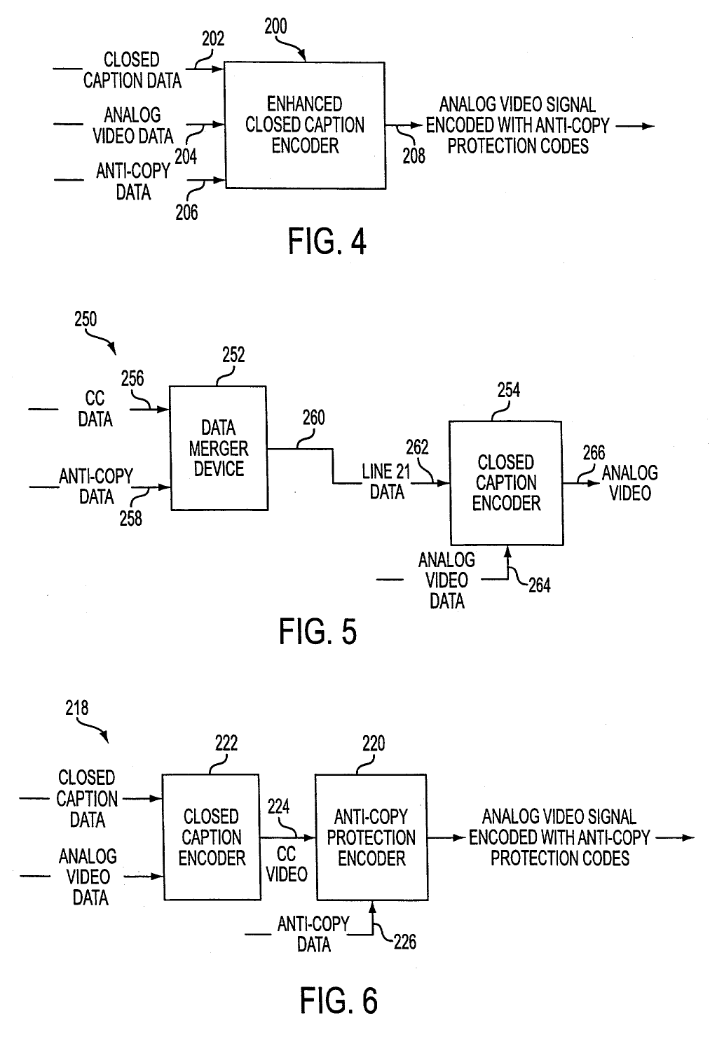

FIG. 4 is a block diagram illustrates an anti-copy protection encoding system 200 of the present invention. The anti-copy protection encoding system 200 includes a closed caption data input 202, an analog video data input 204, an anti-copy protection data input 206, and an encoded analog video signal output 208. The anti-copy protection encoding system 200 is operable to receive the input data and generate at the encoded analog video signal output 208 an analog video signal encoded with the required closed caption and anti-copy protection codes. As will be appreciated, the anti-copy protection encoding system 200 can be implemented in a variety of ways. For example, the anti-copy protection encoding system 200 can be manufactured as an ASIC. In preferred embodiments such as that described below with reference to FIG. 5, the anti-copy protection encoding system 200 is built of distinct components and utilizes a standard CC encoder.

FIG. 5 illustrates a preferred embodiment 250 of the anti-copy protection encoder system 200 of FIG. 4. The anti-copy protection system 250 includes a data merger device 252 coupled to a standard closed caption encoder 254. The data merger device 260 includes a closed caption data input 256, an anti-copy protection data input 258, and a line 21 data output 260. The closed caption encoder 254 includes a closed caption data input 262, an analog video data input 264, and an analog video output 266.

With further reference to FIG. 5, the data merger device 252 merges the closed caption and anti-copy data and provides line 21 data at the line 21 data output 260 to the closed caption encoder 254. In turn, the closed caption encoder 254 inserts the line 21 data onto received analog video data and provides an analog video output with the desired closed caption and anti-copy protection coding in place. Note that “line 21” refers specifically to the NTSC standard, however other suitable standards such as PAL are contemplated by the present invention, and those skilled in the art will readily recognize how to implement the present invention in such standards.

FIG. 6 illustrates an anti-copy protection system encoder 218. The anti-copy protection 218 includes a standard closed caption encoder 222 driving an anti-copy protection encoder 220. The anti-copy protection encoder 220 has an analog video data input 224 and an anti-copy data input 226. Upon receipt of both the video data (possibly) containing CC data and the anti-copy data, the anti-copy protection encoder 220 inserts the anti-copy protection codes into the video signal as required for the desired anti-copy protection mechanism, utilizing any suitable method. For example, either methods of FIGS. 2-3 are suitable for implementation within the anti-copy protection encoder 220 may utilize

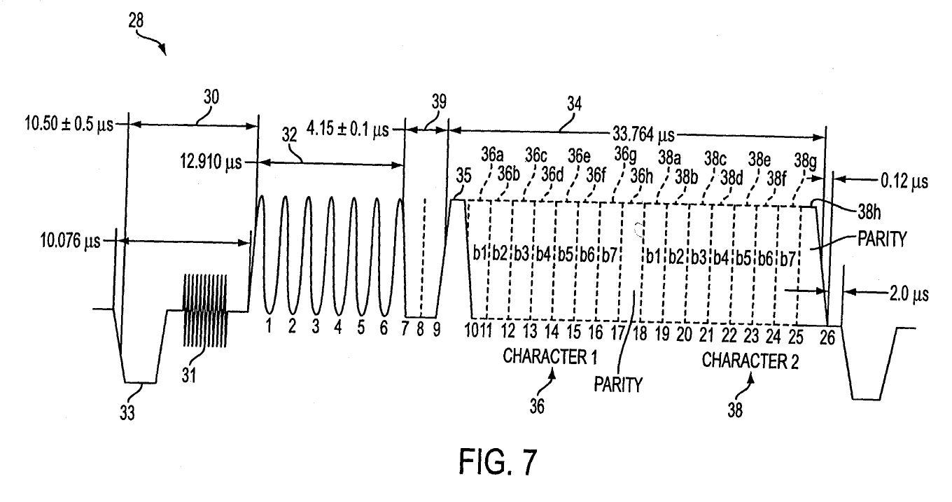

As previously mentioned, in preferred embodiments of the present invention the anti-copy protection is encoded into line 21 of a VBI. Accordingly, a brief discussion of closed caption line 21 encoding is now described. FIG. 7 shows a timing diagram 28 of line 21, Field 1, of the vertical blanking interval of an NTSC video waveform. Line 21 of Field 1 of the NTSC VBI contains the closed caption information. In particular, the location of the closed caption character information is shown as CHARACTER 1 (Ref. 36) and CHARACTER 2 (Ref. 38). Each character is made up of 7 bits plus a parity bit. Any pair of 7 bit characters can be encoded in this location of a video field. A single character can also be identified by special codes that require all 16 bits of CHARACTER 1 and CHARACTER 2. Such codes will be referred to subsequently as two byte character codes.

With further reference to FIG. 7, a horizontal synch pulse 33 and color burst signal 31 are present in the 10.50 microsecond region 30, followed by seven cycles of a 503.5 kHz run in clock in the 12.91 microsecond region 32. Immediately following region 32 is a 4.15 microsecond region 39 for stabilization of the data collection clock. Start bit 35 follows region 39. CHARACTER 1 bits 36a-36h and CHARACTER 2 bits 38a-38h follow start bit 35 in timing region 34. The two eight bit words 36 and 38 are formatted per the USA Standard Code of Information Interchange (USASCII; 3.4-1967) with odd parity. Data clock rate is 503.5 kHz, and is 32 times the horizontal sweep frequency. Similar timing is evident for Field 2, although vertical blanking interval ends at line 283 instead of line 21, and similar character data may be present as outlined in Xtended Data Services (XDS) in EIA-766.

Further reference to character data or closed caption character data in the vertical blanking interval may apply to digital character data stored on line 21 or line 283, as can be appreciated by those skilled in the art. Although the discussion above specifically refers to the NTSC video standard, a similar comparison can be made to video signals conforming to the PAL standard. The specific line locations of the vertical blanking intervals differ for the two formats, however the general signal pattern is similar enough that one skilled in the art would be able to extract closed caption character information from either format. Therefore, it is to be assumed that in subsequent discussion of closed caption character information present in the vertical blanking interval of a video program, either the NTSC or the PAL formats are applicable, in either or both of field 1 or field 2.

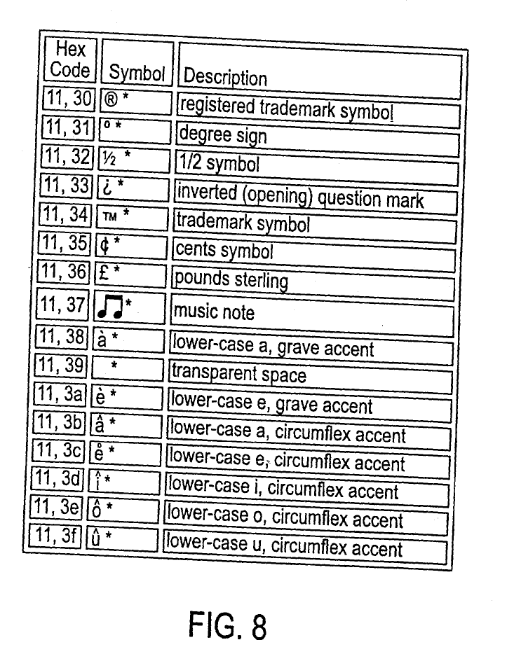

FIG. 8 shows a table of the currently assigned two byte character codes according to the EIA-608 standard. Only 16 characters are represented by the table in this figure. As a result, there are numerous other two byte character codes not assigned the EIA specification that can be used for other purposes. For example the unused code (1F,60) can be used to activate anti-copy protection and the unused code (1F,61) can be used to deactivate anti-copy protection.

FIG. 9 is a flow chart of a method 300 for decoding an analog video program to determine the frequency and nature of anti-copy protection codes for the control of an underlying anti-copy protection mechanism. In preferred embodiments, this method is implemented in hardware within a device such as a set top box. This method may also be performed when an analog video program is being converted into a digital video program in order to provide any desired anti-copy protection within the digital video.

The decoding method 300 begins when a step 302 receives an analog video program. A step 304 monitors the frequency of the anti-copy protection codes present in the analog video program. Determining the anti-copy protection code frequency is easily accomplished by decoding characters embedded in, e.g., line 21 of the VBI and tracking the frequency of matches between the decoded characters and predefined anti-copy protection codes. In preferred embodiments, the receiving device or STB will have CC capability, and parallel processing monitors for and provides any standard closed caption information present in the analog video signal. A step 306 determines the nature of the anti-copy protection encoding in order to control the anti-copy protection mechanism. As described in more detail above, the nature of the anti-copy protection mechanism can be controlled through different anti-copy protection codes and/or the frequency of the anti-copy protection codes embedded in the analog video program. The step 306 is optional as the nature of the anti-copy protection mechanism may be inherent in the anti-copy protection code frequency. A step 308 controls the anti-copy protection mechanism in response to the frequency and/or nature of the anti-copy protection codes.

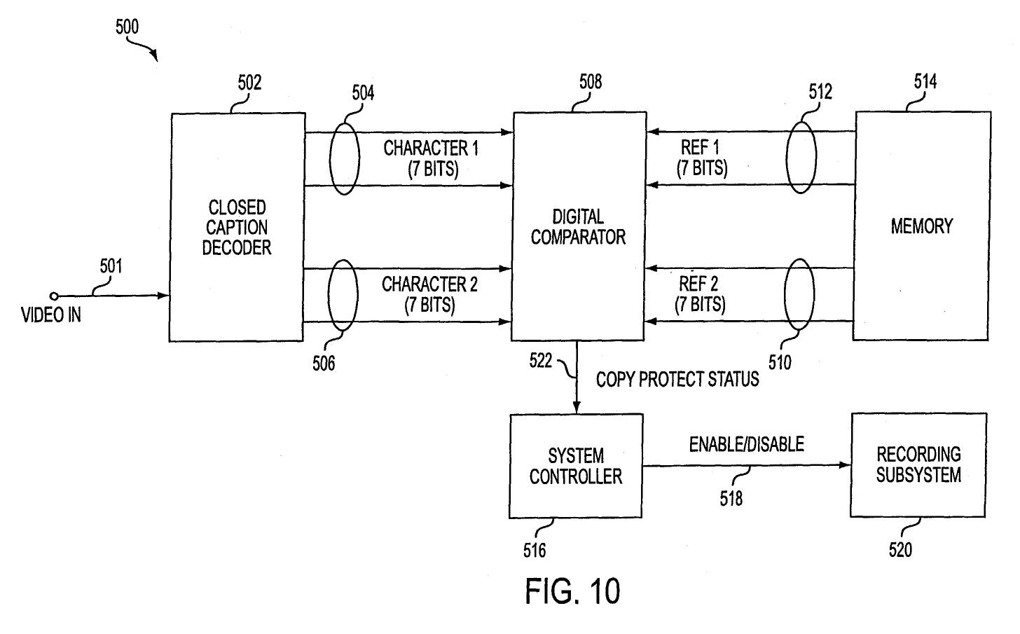

FIG. 10 is a component block diagram showing one possible system 500 suitable for implementing a frequency based decoding method of FIG. 9 in accordance with a two byte character embodiment of the present invention. The system 500 includes a standard closed caption decoder 502, a digital comparator 508, a memory 514, and a system controller 516.

In operation, the analog video program 501 is fed to the standard closed caption decoder 502. The encoded bit patterns for CHARACTER 1 (Ref. 36) and CHARACTER 2 (Ref. 38) are determined by the decoder 502 and transmitted over 8 bit data busses 504 and 506 to the digital comparator 508. The digital comparator 508 receives a previously stored code from the memory 514 via data busses 512 and 510. These previously saved codes may be provided to the user as part of new equipment when purchased, or periodically updated by the user or equipment manufacturer at some later date. Each time a two byte code is matched to a reference code, the comparator 508 transmits a signal (e.g., pulse) to the system controller 516. In turn, the system controller 516 monitors signals from the comparator 508, and controls the anti-copy protection mechanism as required.

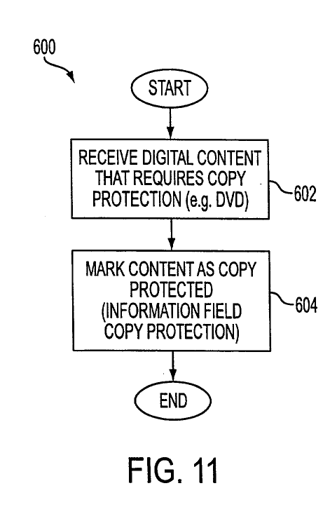

The above description focused on an anti-copy protection mechanism working directly within an analog video platform. Those skilled in the art will readily understand how the above-described embodiments are applicable to a digital video supporting CC encoding. However, the teaching of the present invention is not limited to analog and digital video platforms supporting CC encoding. Accordingly, a method and system for incorporating aspects of the present invention into digital video formats not supporting CC encoding will now be described below with reference to FIGS. 11-13.

FIG. 11 is a flow chart of a method 600 for encoding a digital video program with anti-copy protection information. The method 600 teaches an anti-copy protection data field provided in a predefined location within the digital data. As will be appreciated, data may be inserted into the anti-copy protection data field of the digital video program at any suitable stage during the process of providing the video program to an end user. For example, this may be done during a content authoring process, immediately prior to broadcast, even upon receipt of the digital video program at a STB, etc. While the method 600 is primarily contemplated in the context of a digital video platform that does not support CC encoding, the method 600 certainly could be implemented within a digital video platform that does support CC encoding. This is simply an application detail which can be selected by the system designer.

The method 600 begins in a step 602 which receives the digital content that requires copy protection. The digital video program may be in any suitable format such as DVD. In a step 604, the digital video program is marked as anti-copy protected through the insertion of suitable codes within the anti-copy protection data field. As described above, the anti-copy protection mechanism can support different levels of anti-copy protection as desired. In light of the above discussion, the details of implementation of an anti-copy protection mechanism will be readily apparent to those skilled in the art.

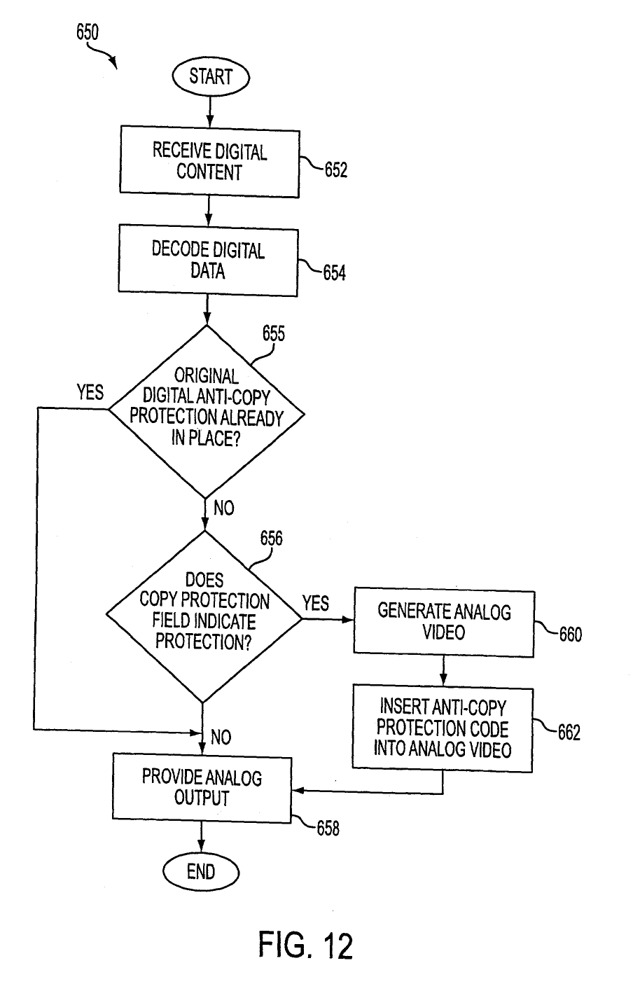

FIG. 12 shows a flow chart of a digital decoding method 650 suitable for enabling the anti-copy protection mechanism of the present invention in conjunction with digitally formatted video content. It is contemplated that the method 650 will occur at a receiving device such as a STB, however this method can be applied at any suitable point in the process of providing video content to a user. For example, a video broadcast server may store a video program in digital format containing the anti-copy protection data field, and convert the video program to a digital format prior to broadcast utilizing the method 650.

In any event, a step 652 receives the digital content for determination of anti-copy protection coding. A step 654 decodes the digital data into a format suitable for analysis. A step 655 analyzes the digital data to determine whether an alternative anti-copy protection mechanism is in place. For example, the digital video platform may have its own anti-copy protection mechanism, or may support the CC encoding anti-copy protection mechanism of the present invention. When the digital video platform has an alternative anti-copy protection mechanism, the method 650 is complete.

With further reference to FIG. 12, when the digital video platform does not support a different anti-copy protection mechanism as determined in the step 655, a step 656 analyzes the digital data to determine the existence and nature of anti-copy protection codes inserted into the anti-copy protection data field. When no anti-copy protection is required, flow control passes to a step 658 wherein an analog video output signal is provided from the digital data. When anti-copy protection is required, a step 660 generates the analog video output signal from the digital data. Then in a step 662, the anti-copy protection codes are inserted into appropriate portions of the analog video program which is then provided as an analog video output with anti-copy protection inserted. The step 662 can be accomplished through methods such as those described above with reference to FIGS. 2-3.

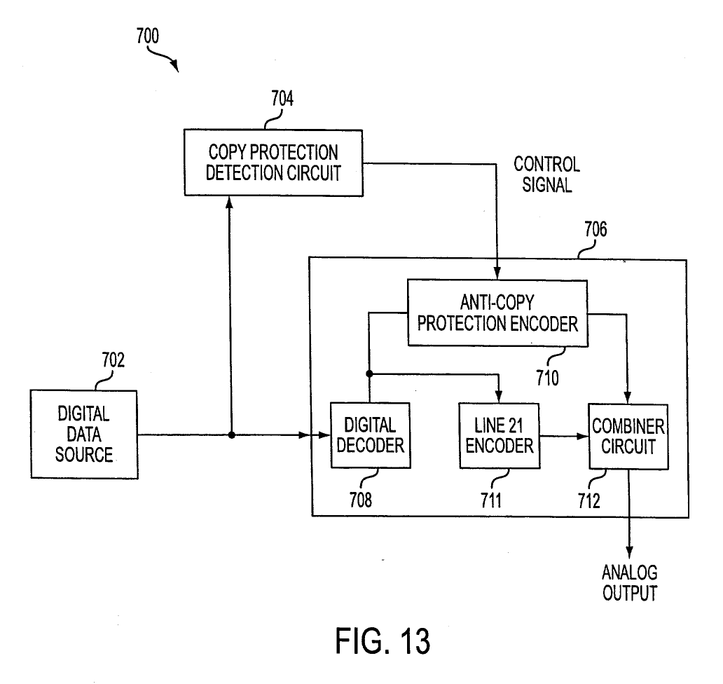

FIG. 13 illustrates a hardware system 700 for the decoding of digital video data and the insertion of anti-copy protection codes in accordance with another embodiment of the preferred invention. The hardware system 700 includes a digital data source 702, an anti-copy protection digital detection circuit 704, and a digital to analog anti-copy protection encoding device 706. The encoding device 706 includes a digital decoder 708, a anti-copy protection encoder 710, a line 21 decoder 711, and a combiner circuit 712. The digital data source 702 provides digitally encoded video data to the encoding device 706 which in turn is fed to the digital decoder 708 for the generation of analog video signals. The detection circuit 704 monitors the digital data to determine whether anti-copy protection is indicated within the anti-copy protection field of the digital video data. In turn the detection circuit 704 is operable to control the anti-copy protection encoder 710 so that anti-copy protection codes are inserted in the required location of the analog video signal. The output of the line 21 encoder 706 and the digital decoder 708 are provided at inputs of the combiner circuit 712. The combiner circuit 712 generates the analog video output with the required anti-copy protection inserted.

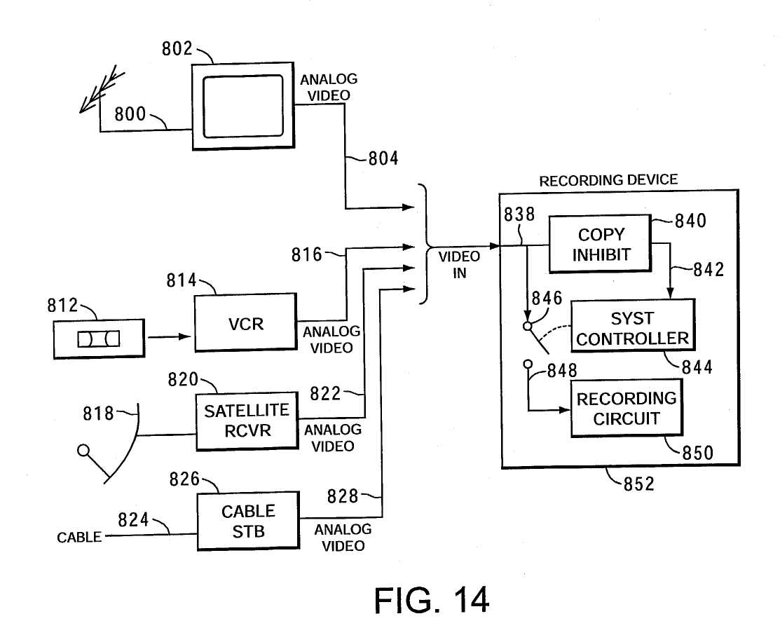

FIG. 14 shows a large variety of program sources that can be encoded with the two byte character codes in accordance with the present invention. A user can receive a standard transmitted broadcast through his conventional antenna 800 connected to a standard TV 802. Item 802 can also be any tuner capable of receiving modulated radio frequency transmission (standard VHF or UHF television) broadcasts. If the program is encoded with closed captioning, then the closed captioning can also include a two byte character pre-assigned to enable or disable the subsequent copying of the broadcast program. In fact, it is not required that the program have closed captioning (although many do) to include such two byte characters, since they can be chosen as “non-printing” and will not be displayed on the user's TV. Analog video signals 804 derived from reception of the broadcast may be sent to the video inputs 838 of a recording device 852.

Video tape 812 may also be encoded with the two byte copy protect characters. Playback of video tapes in VCR 814 may produce a video output 816 containing closed captions visible on the user's TV including the invisible two byte characters, or just a video output with only non-visible two byte characters.

Satellite broadcasts received at antenna 818 are decoded in receiver 820 and produce an analog video signal 822. In a manner similar to that described above for TV broadcasts, these programs may have closed caption information placed into the program prior to broadcast and reception by the end user. Cable broadcasts 824 are treated in a manner similar to satellite and TV broadcasts. A receiver 826 can be a set top box decoder (STB) needed to unscramble “premium” or pay for service channels, or a standard tuner as found in a TV 802 or VCR 814. In any case, broadcast 824 may be encoded with the two byte characters prior to transmission on the cable system. Following reception and decoding (if required), an analog video signal 828 is produced containing the program material.

Any number of the video program signals 804, 816, 822, or 828 shown in FIG. 14 can be sent to a recording device 852 as a video input 838. A copy inhibit module 840 monitors the vertical blanking interval of input 838 and determines if the incoming program is encoded with the appropriate two byte character code. If a code is recognized, a signal 842 is sent to system controller 844. System controller can disable the recording of the program material by recording circuit 850 by opening switch 814, or by any other means known by those skilled in the art. It may also be desirable to enable a limited number of recordings from a source with repeat play capability, such as the VCR 814. In that case, the encoded program material would be decoded by module 840, and a different signal would be sent to the system controller 844. The system controller can be equipped with a memory device to allow storing of an index variable indicating the number of recordings completed, so that no more than the allowed number of recordings can be obtained, even if they are recorded at different times or following the recording of other programs.

As will be appreciated, the anti-copy protection of the present invention can be implemented in a variety of ways. For example, the anti-copy protection may be absolute; that is, when the anti-copy protection mechanism is active copying may be fully prohibited. Alternatively, the active anti-copy protection mechanism may simply cause any recording to be degraded through some mechanism readily understood in the prior art. In more complicated systems, different levels of activation may be provided to the system such that a certain code may correspond to absolute prohibition of copying, while other codes may result in predefined levels of degradation, or other anti-copying protection actions.

What is claimed is:

1. A video encoding method for providing control of an anti-copy protection mechanism for a video program, the video encoding method comprising an act of encoding at least one anti-copy protection code within closed captioning (CC) bandwidth of said video program.

2. A video encoding method as recited in claim 1, said video encoding method further comprising the act of providing said video program.

3. A video encoding method as recited in claim 2, wherein the act of providing said video program includes the act of authoring content of said video program such that the anti-copy protection encoding can be performed in conjunction with said authoring of content of said video program.

4. A video encoding method as recited in claim 2, wherein in the act of providing said video program includes the act of receiving the video program as previously authored video content.

5. A video encoding method as recited in claim 1, wherein said anti-copy protection mechanism is activated at least when a frequency of anti-protection encoding within said video program is greater than or equal to a predefined activation frequency, wherein the act of encoding at least one anti-copy protection code within the closed captioning bandwidth of said video program includes the acts of:
determining certain portions of said video program which require anti-copy protection;
generating anti-copy protection codes; and
inserting anti-copy protection codes within CC bandwidth of said certain portions of said video program at a frequency greater than or equal to said predefined activation frequency.

6. A video encoding method as recited in claim 5, wherein said anti-copy protection mechanism provides for multiple levels of anti-copy protection.

7. A video encoding method as recited in claim 6, wherein said multiple levels of anti-copy protection include a first level degrading subsequent copies of said video program

8. A video encoding method as recited in claim 6, wherein said multiple levels of anti-copy protection include a severe level barring generation of subsequent copies of said video program.

9. A video encoding method as recited in claim 6, wherein said multiple levels of anti-copy protection to insertion frequency ranges of said anti-copy protection codes.

10. A video encoding method as recited in claim 2, said video encoding method further comprising the act of generating CC data suitable for encoding in said video program.

11. A video encoding method as recited in claim 10, wherein said CC data is encoded into said video program prior to encoding said at least one anti-copy protection code prior.

12. A video encoding method as recited in claim 11, wherein said anti-copy protection codes are inserted into said video program without analyzing said video program to determine whether CC data is encoded therein.

13. A video encoding method as recited in claim 12, wherein said anti-copy protection codes are inserted into least used portions of said CC bandwidth.

14. A video encoding method as recited in claim 11, further including the act of analyzing said CC bandwidth of said video program to enable the encoding of said anti-copy protection codes within unused portions of said CC bandwidth.

15. A video encoding method as recited in claim 1, wherein said anti-copy protection mechanism provides for multiple levels of anti-copy protection.

16. A video encoding method as recited in claim 15, wherein said multiple levels of anti-copy protection include a first level degrading subsequent copies of said video program

17. A video encoding method as recited in claim 15, wherein said multiple levels of anti-copy protection include a severe level barring generation of subsequent copies of said video program.

18. A video encoding method as recited in claim 15, wherein each of said multiple levels of anti-copy protection mechanism has a corresponding anti-copy protection code.

19. A video encoding method as recited in claim 16, further including the acts of:
determining certain portions of said video program which require anti-copy protection;
determining a desired level of anti-copy protection for each of said certain portions of said video program;
generating any required anti-copy protection codes; and
inserting anti-copy protection codes within said certain portions of said video program as indicated by the desired level of anti-copy protection.

20. A video encoding method as recited in claim 1, wherein said anti-copy protection mechanism is activated at least when a frequency of anti-protection encoding within said video program is less than or equal to a predefined frequency, wherein the act of encoding at least one anti-copy protection code within the closed captioning bandwidth of said video program includes the acts of:
determining certain portions of said video program which do not require anti-copy protection;
generating anti-copy protection codes; and
inserting anti-copy protection codes within CC bandwidth of said certain portions of said video program which do not require anti-copy protection at a frequency greater than or equal to said predefined frequency.

21. A video encoding method as recited in claim 1, wherein the video program is an analog video program.

22. A video encoding method as recited in claim 1, wherein the CC bandwidth utilized is line 21 of the vertical blanking interval (VBI).

23. A computer readable medium encoded with a video encoding method for providing control of an anti-copy protection mechanism for a video program, the computer readable medium comprising a computer executable instruction for encoding at least one anti-copy protection code within closed captioning (CC) bandwidth of said video program.

24. A video program comprising at least one anti-copy protection code encoded within a portion of said video program intended for use in providing closed caption (CC) data, said at least one anti-copy protection code operable to control an anti-copy protection mechanism implemented on a video device.

25. A video program as recited in claim 24, wherein said video program is an analog video program supporting CC encoding.

26. A video program as recited in claim 25, wherein said CC encoding adheres to an EIA-608 standard and said at least one anti-copy protection code is a multiple byte character code inserted into a line 21 of a vertical blanking interval (VBI) of said analog video program.

27. A video program as recited in claim 26, wherein said multiple byte character is a previously unused 2-byte character code.

28. A video program as recited in claim 27, wherein said 2-byte character code is the character code (1F, 60).

29. A video program as recited in claim 27, wherein said 2-byte character code is the character code (1F, 61).

30. A video program as recited in claim 24, wherein said anti-copy protection mechanism is responsive to a frequency of insertion of said anti-copy protection codes, certain portions of said video program being encoded with anti-copy protection codes such at a frequency of insertion such that said anti-copy protection mechanism is controlled as desired.

31. A video program as recited in claim 30, wherein activation of said anti-copy protection mechanism is initiated when said frequency of insertion of said anti-copy protection codes is greater than or equal to an anti-copy protection initiation frequency.

32. A video program as recited in claim 31, wherein said anti-copy protection mechanism is maintained in an on state when said frequency of insertion of said anti-copy protection codes is greater than or equal to an anti-copy protection maintenance frequency, wherein said anti-copy protection maintenance frequency may be less than said anti-copy protection initiation frequency.

33. A video program as recited in claim 30, wherein activation of said anti-copy protection mechanism is initiated when said frequency of insertion of said anti-copy protection codes is less than or equal to an anti-copy protection initiation frequency.

34. A video program as recited in claim 30, wherein said anti-copy protection mechanism provides multiple levels of anti-copy protection.

35. A video program as recited in claim 34, wherein each of said multiple levels of anti-copy protection has a corresponding anti-copy protection code.

36. A video program as recited in claim 34, wherein each of said multiple levels of anti-copy protection correspond to a range of anti-copy protection code insertion frequencies.

37. A video program as recited in claim 24, wherein said anti-copy protection mechanism provides multiple levels of anti-copy protection.

38. A video program as recited in claim 37, wherein each of said multiple levels of anti-copy protection has a corresponding anti-copy protection code.

39. A video program as recited in claim 24, wherein said video program is a digital video program.

40. A data carrier wave such as a video signal, said data carrier wave comprising at least one anti-copy protection code encoded within a portion of said data carrier wave intended for use in providing closed caption (CC) data, said at least one anti-copy protection code operable to control an anti-copy protection mechanism implemented on a video device.

41. A data carrier wave as recited in claim 40, wherein said data carrier wave is an analog data carrier wave supporting CC encoding.

42. A data carrier wave as recited in claim 41, wherein said CC encoding adheres to an EIA-608 standard and said at least one anti-copy protection code is a multiple byte character code inserted into a line 21 of a vertical blanking interval (VBI) of said analog data carrier wave.

43. A data carrier wave as recited in claim 42, wherein said multiple byte character is a previously unused 2-byte character code.

44. A data carrier wave as recited in claim 43, wherein said 2-byte character code is the character code (1F, 60).

45. A data carrier wave as recited in claim 43, wherein said 2-byte character code is the character code (1F, 61).

46. A data carrier wave as recited in claim 40, wherein said anti-copy protection mechanism is responsive to a frequency of insertion of said anti-copy protection codes, certain portions of said data carrier wave being encoded with anti-copy protection codes such at a frequency of insertion such that said anti-copy protection mechanism is controlled as desired.

47. A data carrier wave as recited in claim 46, wherein activation of said anti-copy protection mechanism is initiated when said frequency of insertion of said anti-copy protection codes is greater than or equal to an anti-copy protection initiation frequency.

48. A data carrier wave as recited in claim 47, wherein said anti-copy protection mechanism is maintained in an on state when said frequency of insertion of said anti-copy protection codes is greater than or equal to an anti-copy protection maintenance frequency, wherein said anti-copy protection maintenance frequency may be less than said anti-copy protection initiation frequency.

49. A data carrier wave as recited in claim 46, wherein activation of said anti-copy protection mechanism is initiated when said frequency of insertion of said anti-copy protection codes is less than or equal to an anti-copy protection initiation frequency.

50. A data carrier wave as recited in claim 46, wherein said anti-copy protection mechanism provides multiple levels of anti-copy protection.

51. A data carrier wave as recited in claim 50, wherein each of said multiple levels of anti-copy protection has a corresponding anti-copy protection code.

52. A data carrier wave as recited in claim 50, wherein each of said multiple levels of anti-copy protection correspond to a range of anti-copy protection code insertion frequencies.

53. A data carrier wave as recited in claim 40, wherein said anti-copy protection mechanism provides multiple levels of anti-copy protection.

54. A data carrier wave as recited in claim 53, wherein each of said multiple levels of anti-copy protection has a corresponding anti-copy protection code.

55. A data carrier wave as recited in claim 40, wherein said data carrier wave is a digital data carrier wave.

56. An anti-copy protection video program encoding system, said encoding system operable to insert anti-copy protection codes within closed captioning bandwidth of a video program.

57. An anti-copy protection video program encoding system as recited in claim 56, said encoding system comprising:
a data merger device having a first CC data input, an anti-copy data input, and a CC data output, said data merger device operable to merge data received at said anti-copy data input and said specific CC data output; and
a CC encoder having a second CC data input coupled to said data merger device CC data output, a video data input, and a video data output, said closed caption encoder operable to encode data received at said second CC data input within a CC bandwidth portion of a video program received at said video input.

58. An anti-copy protection video program encoding system as recited in claim 56, wherein said encoding system is responsive to an analog video program.

59. An anti-copy protection video program encoding system as recited in claim 56, wherein said encoding system is responsive to a digital video program.

60. An anti-copy protection video program encoding system as recited in claim 57, wherein said encoding system inserts anti-copy protection codes within line 21 of the vertical blanking interval (VBI) of the video program.

61. An anti-copy protection video program encoding system as recited in claim 56, wherein an anti-copy protection mechanism is activated at least when a frequency of anti-protection encoding within said video program is greater than or equal to a predefined activation frequency, wherein the encoding system is further operable to:
determine certain portions of said video program which require anti-copy protection;
generate anti-copy protection codes; and
insert anti-copy protection codes within CC bandwidth of said certain portions of said video program at a frequency greater than or equal to said predefined activation frequency.

62. A video encoding system as recited in claim 61, wherein said anti-copy protection mechanism provides for multiple levels of anti-copy protection.

63. A video encoding system as recited in claim 62, wherein said multiple levels of anti-copy protection include a first level degrading subsequent copies of said video program

64. A video encoding system as recited in claim 62, wherein said multiple levels of anti-copy protection include a severe level barring generation of subsequent copies of said video program.

65. A video encoding system as recited in claim 63, wherein said multiple levels of anti-copy protection correspond to frequency ranges of said anti-copy protection codes.

66. A video encoding system as recited in claim 56, said encoding system comprising:
a CC encoder having a CC data input, a video data input, and a video data output, said closed caption encoder operable to encode data received at said CC data input within a CC bandwidth portion of a video program received at said video data input, and further to output an CC encoded video program at said video output; and
an anti-copy protection encoder having a CC encoded video program input, an anti-copy protection code input, and an anti-copy protection encoded video output, said anti-copy protection encoder operable to encode anti-copy protection codes received at said anti-copy protection code input within a video program received at said CC encoded video program input.

67. A video encoding system as recited in claim 66, said anti-copy protection encoder operable to insert said anti-copy protection codes said video program without analyzing said video program to determine whether CC data is encoded therein.

68. A video encoding system as recited in claim 67, wherein said anti-copy protection codes are inserted into least used portions of said CC bandwidth.

69. A video encoding system as recited in claim 66, said anti-copy protection encoder operable to analyze said CC bandwidth of said video program to enable the encoding of said anti-copy protection codes within unused portions of said CC bandwidth.

70. A video encoding system as recited in claim 56, wherein said anti-copy protection mechanism provides for multiple levels of anti-copy protection.

71. A video encoding system as recited in claim 70, wherein said multiple levels of anti-copy protection include a first level degrading subsequent copies of said video program

72. A video encoding system as recited in claim 70, wherein said multiple levels of anti-copy protection include a severe level barring generation of subsequent copies of said video program.

73. A video encoding system as recited in claim 15, wherein each of said multiple levels of anti-copy protection mechanism has a corresponding anti-copy protection code.

74. A video encoding system as recited in claim 70, said anti-copy protection encoder operable for:
determining certain portions of said video program which require anti-copy protection;
determining a desired level of anti-copy protection for each of said certain portions of said video program;
generating any required anti-copy protection codes; and
inserting anti-copy protection codes within said certain portions of said video program as indicated by the desired level of anti-copy protection.

75. A video encoding system as recited in claim 56, wherein an anti-copy protection mechanism is activated at least when a frequency of anti-protection encoding within said video program is less than or equal to a predefined frequency, wherein the encoding system is operable for:
determining certain portions of said video program which do not require anti-copy protection;
generating anti-copy protection codes; and
inserting anti-copy protection codes within CC bandwidth of said certain portions of said video program which do not require anti-copy protection at a frequency greater than or equal to said predefined frequency.

76. An anti-copy protection method for providing control of an anti-copy protection mechanism for a video program, the anti-copy protection method comprising the acts of:
receiving a video program;
analyzing a CC portion of said video program for anti-copy protection codes.

77. An anti-copy protection method as recited in claim 76 further comprising an act of controlling said anti-copy protection mechanism as indicated by said anti-copy protection codes.

78. An anti-copy protection method as recited in claim 77, wherein said anti-copy protection mechanism is activated at least when a frequency of anti-protection encoding within said video program is greater than or equal to a predefined activation frequency, wherein the act of analyzing the anti-copy protection codes within the CC portion of said video program includes the act of determining the frequency of anti-protection encoding within said video program.

79. An anti-copy protection method as recited in claim 76, wherein said anti-copy protection mechanism provides for multiple levels of anti-copy protection, said anti-copy protection method further including the act of determining from said anti-copy protection codes an indicated level of anti-copy protection.

80. An anti-copy protection method as recited in claim 79, wherein said multiple levels of anti-copy protection correspond to insertion frequency ranges of said anti-copy protection codes.

81. An anti-copy protection method as recited in claim 79, wherein said multiple levels of anti-copy protection correspond to specific anti-copy protection codes.

82. An anti-copy protection method as recited in claim 79 wherein said multiple levels of anti-copy protection include a first level degrading subsequent copies of said video program

83. An anti-copy protection method as recited in claim 79, wherein said multiple levels of anti-copy protection include a severe level barring generation of subsequent copies of said video program

84. A method for anti-copy protection in an video program comprising:
encoding a video program with a two byte character code in a vertical blanking interval of a video field such that said two byte character code may be decoded in a video recording device in order to disable a recording process of said video program; and
disabling said recording process in response to a content of said two byte character code.

85. A method for copy-protecting a video program as recited in claim 84, wherein said video program is encoded prior to recording on a DVD.

86. A method for copy-protecting a video program as recited in claim 84, wherein said video program is encoded prior to broadcast via a satellite system.

87. A method for copy-protecting a video program as recited in claim 84, wherein said video program is encoded prior to transmission over a cable network.

88. A method for copy-protecting a video program as recited in claim 84, wherein said video program is encoded prior to broadcast via modulated radio frequency transmission.

89. A method for copy-protecting a video program as recited in claim 84, wherein said video program is encoded prior to distribution over a digital network system.

90. A method for copy-protecting a video program as recited in claim 84, wherein said video recording device comprises a video tape recorder.

91. A method for copy-protecting a video program as recited in claim 84, wherein said video recording device comprises a digital storage device.

92. A method for copy-protecting a video program as recited in claim 91, wherein said digital storage device comprises an MPEG recorder.

93. A method for copy-protecting a video program as recited in claim 84, wherein said content of said two byte character code is indicative of a maximum number of allowed recordings of said video program.

94. A method for copy-protecting a video program as recited in claim 84 further comprising:
storing a reference two byte code in a video recording device;
comparing said reference two byte character code with said two byte character code; and
disabling said recording process based on a comparison of said two byte character code and said reference two byte character code.

95. A method for recording a copy-protected video program with a video recording device comprising:
decoding a two byte character code in a vertical blanking interval of a video field; and
enabling recording of said video program in response to said two byte character code.

96. The method of claim 95 including recording said video program with said video ecording device.

97. The method of claim 96, wherein said two byte character code has a value, indicative of the number of times said video program may be played back from said video recording device based on said value of said two byte character code.

98. A method as recited in claim 95, wherein said video program is encoded prior to broadcast via a satellite system.

99. A method as recited in claim 95, wherein said video program is encoded prior to transmission over a cable network.

100. A method as recited in claim 95, wherein said video program is encoded prior to distribution over a digital network system.

101. A method as recited in claim 96, wherein said video recording device comprises a digital storage device.

102. A method as recited in claim 101, wherein said digital storage device comprises a set top box.

103. A method as recited in claim 101, wherein said digital storage device comprises a computer system.

104. The method as recited in claim 96 further comprising:
storing a reference two byte code in a video recording device;
comparing said reference two byte character code with said two byte character code; and
determining the number of times said video program may be played back from said video recording device based on a comparison of said two byte character code and said reference two byte character code.

105. An apparatus for preventing the recording of copy protected video programs comprising:
a decoding device for decoding closed caption character codes in a video program;
a memory operative for storing a reference code;
a comparator for comparing said reference code with said closed caption character codes in order to produce an output responsive to said reference code and said closed caption character codes; and
a control device operative to prevent recording of said video program in response to said output of said comparator.

106. The apparatus of claim 105, including a recording device for producing a recording of said video program.

107. An apparatus to prevent the recording of copy protected video programs as recited in claim 106 wherein said recording device is a video tape recorder.

108. An apparatus to prevent the recording of copy protected video programs as recited in claim 106 wherein said recording device is a digital storage device.

109. An apparatus to prevent the recording of copy protected video programs as recited in claim 108 wherein said digital storage device is a MPEG recorder.

110. An apparatus to prevent the recording of copy protected video programs as recited in claim 108 wherein said digital storage device is a computer system.

111. An apparatus to prevent the recording of copy protected video programs as recited in claim 106 wherein said control device allows the formation of at least one recording of said video program by said recording device based on said output of said comparator.

112. An apparatus to prevent the recording of copy protected video programs as recited in claim 106 further comprising:
a playback device for playback of said recorded video program, and
wherein said control device limits the number of times said recorded video program may be played back based on the output of said comparator.

113. The apparatus as recited in claim 105, wherein said closed caption character code includes a two byte character code in a vertical blanking interval of a video field of said video program, and wherein said reference code includes a reference two byte character code.

114. The apparatus of claim 106, wherein said comparator provides at least one output signal in response to said closed caption character code being equal to said reference code, and wherein said control device is operative to disable said recording device for a predetermined time interval in response to said output signal, said control device being further operative to extend said predetermined time interval in response to one or more additional said output signals.

115. The apparatus of claim 105, wherein said comparator compares said reference code with said closed caption character code at a regular time interval, and wherein said comparator provides at least one output signal in response to said closed caption character code being equal to said reference code.

116. The apparatus of claim 115, wherein said control device is operative to disable said recording device for a predetermined time interval in response to said output signal, said control device being further operative to extend said predetermined time interval in response to one or more additional said output signals.

117. The apparatus of claim 105, wherein a closed caption character string is partially comprised of said closed caption character code, and wherein said comparator is operative to determine the location of said closed caption character code within said closed caption character string.

118. A video transmission receiver for receiving copy protected video programs, comprising:
a decoding device for decoding copy protection codes incorporated in a video program;
a memory operative for storing a reference code;
a comparator for comparing said reference code with said copy protection codes in order to produce an output responsive to said reference code and said copy protection codes;
a control device operative to limit recording and playback of said video program in response to said output of said comparator; and
a recording device for recording and playback of said video program.

119. A video transmitter for creating copy protected video programs, comprising an encoding device for placing a two byte character code in a vertical blanking interval of a video field.

120. The video transmitter of claim 119, wherein said two byte character code is encoded as field 1, text position 2 and field 2 text position 3.

121. The video transmitter of claim 119, further comprising a DVD recorder.

122. The video transmitter of claim 119, further comprising a satellite system.

123. The video transmitter of claim 119, further comprising a cable network.

124. The video transmitter of claim 119, further comprising a modulated radio frequency transmitter.

125. The video transmitter of claim 119, further comprising a digital network.

126. The video transmitter of claim 119, further comprising a video recorder.

127. A method for copy-protecting a video program as recited in claim 84, wherein said two byte character code is encoded as field 1, text position 2 and field 2 text position 3.

128. A method for copy-protecting a video program as recited in claim 84, wherein said video program is encoded prior to recording on a video tape.
